(19) United States
(12) Patent Application Publication
(10) Pub. No.: US 2008/0118720 A1
(43) Pub. Date: May 22, 2008

(54) Lid, in Particular for Food Packaging, or Label, in Particular for the Neck of a Bottle

(75) Inventors: Konstantin Thomas, Weiden (DE); Heinrich Haase, Weiden (DE); Andreas Eger, Vohenstrauss (DE); Manfred Trager, Weiden (DE)

Correspondence Address: BROWDY AND NEIMARK, P.L.L.C.;624 NINTH STREET, NW, SUITE 300, WASHINGTON, DC, 20001-5303, US

(73) Assignee: Hueck Folien GmbH & Co. KG, Pirk (DE)

(21) Appl. No.: 11/660,546

(22) PCT Filed: Aug. 2, 2005
(86) PCT No.: PCT/EP05/08330

§ 371 Date: Oct. 2, 2007

(30) Foreign Application Priority Data
Aug. 20, 2004 (DE) 102004040347.3
Apr. 18, 2005 (DE) 202005006038.0

(51) Int. Cl. B32B 15/20; B32B 29/06; B32B 3/02

(52) U.S. Cl. 428/209; 428/195.1; 428/211.1

(57) ABSTRACT

In a lid, in particular for food packaging, such as yogurt containers or the like, or a label, in particular a label for the neck of a bottle, comprising an embossed aluminum foil or an embossed aluminum composite foil, plastic foil, plastic composite foil, paper foil or paper composite foil, provision is made, in order to attain appealing surface properties, the feasibility of printing even small characters, and an effective separation process, for the embossing to consist of a plurality of approximately parallel embossed lines, wherein preferably at least some embossed line have interruptions and/or at least in sections, different widths and/or different embossing depths.

The invention relates to a lid, in particular for food packaging, such as yogurt containers or the like, or to a label, in particular a label for the neck of a bottle, comprising an embossed aluminum foil or an embossed aluminum composite foil, plastic foil, plastic composite foil, paper foil, or paper composite foil.

Known embossed foils of this type have the advantage that the individual foil sections, or lids, if they are processed starting from a stack, are easy to separate, i.e., the respective lid that is located on top can be reliably removed from the stack.

A shortcoming of embossed films of this type still lies in that the embossing diminishes the print quality of an imprint that is provided on the upper side of the lid, and especially small filigreed characters or pictures can be distinguished only to a limited degree. Moreover, the reflectance of such known embossed foils is limited, because the reflection is diffuse and nondirectional.

EP 1 340 694 A2 describes a substantially unembossed lid, on the inside of which spacer naps are printed to facilitate the separation process.

From EP 0 883 489 B1, it is known to provide a surface-rough coating that is at least partially sealable. A shortcoming of this product lies in that additional lacquer for surface elements must be applied.

With this as the starting point, the invention is based on the object of creating a lid, or a label, in particular a label for the neck of a bottle, with an appealing surface that permits printing of even small characters and also pictures and that has an advantageous reflectance. It is a goal to prevent Moiré effects. It is also a goal to permit an effective separation process.

This object is met according to the invention in such a way that the embossing consists of a plurality of approximately parallel embossed lines, wherein preferably at least some embossed lines have interruptions, and/or widths that vary at least in sections, and/or different embossing depths.

Width, in this context, shall be taken to mean the dimension that extends in the plane defined by the lid. This design prevents the lids in the stack from becoming entangled with one another. This means that a good separation is achieved. Moreover, a very even grain is obtained, the characters are very legible, the surface has no visible creases, like a smooth foil for example, and the reflectance is almost as good as that of a foil with a smooth surface.

In summary, the invention may be presented as follows in comparison with the prior art:

Known embossed foil tops, e.g., with a worm-pattern embossing, have the shortcoming that characters are poorly legible, they have a busy appearance, e.g., in the case of photographic images, and the EAN codes are not very legible.

While the previously known smooth foil tops are very legible, they necessitate an additional application of lacquer to attain the required surface roughness in the form of spacers, which causes additional costs. Moreover, the visual appearance does not stand up to strict demands in that such foil tops are less sturdy and, after being sealed onto the containers become slightly wavy or exhibit dents, which is not seen in the case of embossed foil tops.

In accordance with the invention, in contrast, good legibility is attained even of fine characters or EAN codes, a matte/gloss effect is made possible along with good legibility like in a smooth foil top, and improved rendering of printed images is attained, wherein the matte/gloss effect can be influenced through the embossing.

The interruptions may be arranged relative to each other under formation of an image, but at different locations on the lid. Provision is made in this context for the interruptions to be arranged irregularly. This design prevents the embossed lines of adjacent lids in a stack from engaging into one another and the lids thus becoming entangled with one another.

In accordance with an advantageous design, each embossed line has a constant width. The embossing in this case is particularly uniform.

At least one embossed line, however, may also have two or more different widths and/or embossing depths.

The embossed lines are preferably designed non-uniform with respect to their widths. This non-uniformity, again, particularly effectively prevents the lids in a stack from becoming entangled with one another.

These irregularities may take very different forms. For example, the embossed lines may have lateral bulges, optionally in addition to interruptions or changes in depth. Moreover, the option exists for the raised areas that remain between the embossed lines to be formed irregular in themselves, e.g., for them to have flattened regions, or the like.

The preferred utilized embossing is a fluted embossing in which, for example, uniform deepenings are placed at specific intervals. The appearance, matte or glossy, is attained through an additional mechanical processing in which the lines are treated with a tool in such a way that a reshaping occurs. The reshaped portions become glossier. The design thereby receives an unmistakable visual character.

The inventive design also permits imprinting with fine characters on the inside of the lid, which, due to the inventive embossing, is equally easily legible as the described imprint on the outside.

Alternatively, provision may also be made for the embossed lines to be arranged with irregular spacing.

The invention will be described in more detail below based on preferred embodiments in conjunction with the drawing, in which:

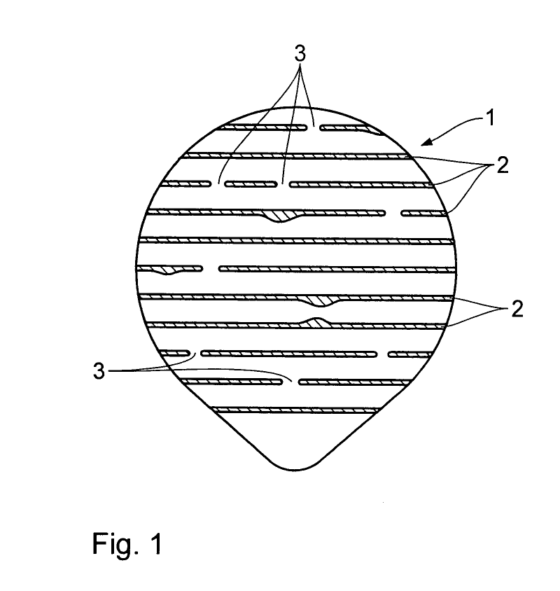

FIG. 1 shows a top view of an inventive yogurt-container lid according to a first embodiment,

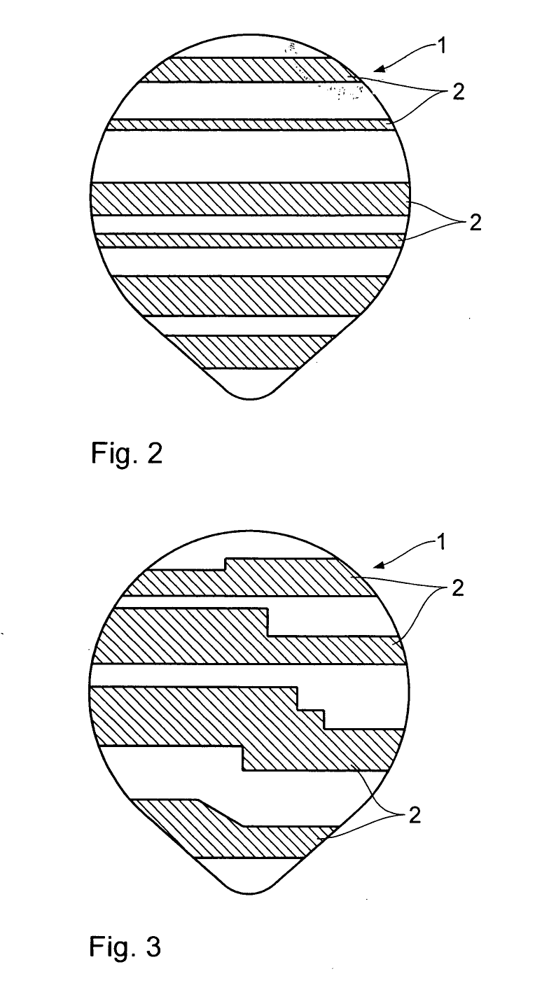

FIG. 2 shows a top view of an inventive yogurt-container lid according to an additional embodiment, and

FIG. 3 shows a top view of an inventive yogurt-container lid according to an additional embodiment.

The yogurt-container lid 1 shown in FIG. 1 is produced from a foil. It has a thickness of 38 μm. The lid 1 is produced by die-cutting. Its upper side has an imprint, whereas its underside is provided with a hot-seal coating. Provided on the lid 1 is an embossing, which has a depth of 30 μm. The embossing is formed of embossed lines 2 that extend parallel to each other and that have a constant spacing relative to each other. The embossed lines 2 have a width of 200 μm. Provided are 25 embossed lines 2 per cm. Some of the embossed lines 2 are interrupted by interruptions 3. These embossing-free sections create quasi-protruding spacers, which reliably prevent individual lids 1 in a stack from becoming entangled with one another. The interruptions 3 may also extend over multiple embossed lines 2. They may be formed circular, for example. The diameter of the interruptions 3 is then approximately 1 mm. As is apparent from FIG. 1, the interruptions 3 are arranged irregularly on the lid 1. The embossing thus exhibits an irregularity. Consequently, no specific pattern exists.

When used as a label for the neck of a bottle, e.g., for a beer bottle, a hachure of 25 l/cm may be used. The embossed lines are parallel to each other. The ridge width is 100 μm (at the top) and the groove width is 100 μm (at the bottom). The ridge spacing is 200 μm. The total thickness with embossing is 60 to 90 μm at an embossing depth of approximately 50 μm.

According to another embodiment, the interruptions are formed different in their shape. Consequently, different spacers exist with respect to shape.

An additional example embodiment of the invention will be described below with reference to FIG. 2. In contrast to the example embodiment according to FIG. 1, the description of which is hereby referred to, the embossed lines 2 have different widths. Each embossed line 2 is formed, however, with a constant, i.e., unchanging width. The width of the embossed lines 2 ranges from 0.02 mm to 0.06 mm. The spacing between the individual embossed lines 2 in this case is non-uniform. However, identical spacings between the individual embossed lines 2 may exist as well. The embossing exhibits an irregularity in this case as well. This irregularity is achieved through the spacing of the embossed lines 2 relative to each other and/or through their different widths.

An additional example embodiment will be described below with reference to FIG. 3. Compared to the example embodiment according to FIG. 2, the description of which is hereby referred to, in this case not every embossed line 2 is formed with a constant width. The width of an embossed line 2 changes over its course. The width may steadily or suddenly increase or decrease. In some regions the embossed lines 2 may have identical widths. However, embossed lines 2 with a constant width may be provided in this case as well. The embossing again exhibits an irregularity. This irregularity is achieved through the spacing of the embossed lines 2 relative to each other and/or through their changing widths.

The described example embodiments can also be combined with each other. A yogurt-container lid may, for example, also have embossed lines of different widths that are additionally also interrupted.

The embossed lines 2 and the interruptions 3 in the Figures are not depicted with their true proportion of dimensions relative to each other and/or relative to the lid dimensions. The figures are intended merely to illustrate the core idea of the invention.

In an example embodiment not shown in the drawing, provision is made for a 38 μm thick foil top that is imprinted on one side and provided with a hot-seal lacquer on the other side, to have an embossing of 25 lines per cm, the embossing depth of which varies between 0 and 35 μm, in order to prevent in this manner that the individual foil tops in the stack become entangled with one another.

1. A lid, in particular for food packaging, such as yogurt containers or the like, or a label, in particular a label for the neck of a bottle, comprising an embossed aluminum foil or an embossed aluminum composite foil, plastic foil, plastic composite foil, paper foil or paper composite foil, wherein the embossing consists of a plurality of approximately parallel embossed lines (2).

2. A lid or label according to claim 1, wherein at least some embossed lines (2) have at least one interruptions (3) and/or, at least in sections, different widths and/or different embossing depths.

3. A lid or label according to claim 1, wherein the interruptions (3) are arranged relative to each other under formation of an image, but at different locations on the lid.

4. A lid or label according to claim 1, wherein the interruptions (3) are arranged irregularly.

5. A lid or label according to claim 1, wherein each embossed line (2) has a constant width.

6. A lid or label according to claim 1, wherein at least one embossed line (2) has at least one of two different widths and/or embossing depths.

7. A lid or label according to claim 1, wherein at least one embossed line (2) has a plurality of at least one of different widths and/or embossing depths.

8. A lid or label according to claim 1, wherein the embossed lines (2) are created non-uniform with respect to their width.

9. A lid or label according to claim 1, wherein the embossed lines (2) are arranged with irregular spacing.

10. A lid or label according to claim 1, wherein it has a thickness between 20 and 100 μm.

11. A lid or label according to claim 1, wherein the depth of the embossed lines (2) is 0 to 40 μm, preferably approximately 30 μm.

12. A lid or label according to claim 1, wherein the width of the embossed lines (2) is 100 to 300 μm, preferably approximately 200 μm.

13. A lid or label according to claim 1, wherein 10 to 50 embossed lines (2) are provided per cm, preferably approximately 25 embossed lines (2) per cm.

14. A lid or label according to claim 1, wherein the diameter of the interruptions (3) is 0.2 to 10 mm, preferably approximately 1 mm.

15. A lid or label according to claim 1, wherein the width of the embossed lines (2) is approximately 0.02 to 0.06 mm.
